(19) United States
(12) Patent Application Publication
(10) Pub. No.: US 2023/0268647 A1
(43) Pub. Date: Aug. 24, 2023

(54) Method for Determining Mutual Coupling

(71) Applicant: Nokia Solutions and Networks OY, Espoo (FI)

(72) Inventor: Jaegeun Ha, New Providence, NJ (US)

(21) Appl. No.: 18/112,566

(22) Filed: Feb. 22, 2023

(30) Foreign Application Priority Data
Feb. 23, 2022 (FI) 20225162

(51) Int. Cl. H01Q 3/36

(52) U.S. Cl. CPC H01Q 3/36

(57) ABSTRACT

An apparatus including: a phased array antenna for transmitting/receiving beamformed signals on a plurality of beams using a common frequency- and time-limited physical channel resource; said phased array antenna including: an array of antenna cells for electromagnetic radiation, wherein the antenna cells include: an antenna element; a first coupling structure at a first side of the antenna element for manipulating coupling with an adjacent antenna cell at a first side of the antenna element; a second coupling structure at a second side of the antenna element opposite to the first side for manipulating coupling with another adjacent antenna cell at the second side of the antenna element; a coupling factor of the first coupling structure differing from a coupling factor of the second coupling structure; wherein adjacent antenna cells of the array of antenna cells are mirror-symmetric structures.

### TECHNICAL FIELD

The present invention relates to determining inter-beam interference.

### BACKGROUND

Today's and future wireless communication systems, such as Long Term Evolution (LTE) or 5^{th} Generation (5G), also referred to as New Radio (NR), have been envisaged to use multiple input-multiple output (MIMO) multi-antenna transmission techniques. Constantly increasing requirements for high throughput motivates the wireless communication systems, such as 5G, to use the mmWave (millimeter wave) frequencies due to available high bandwidth.

Phased array is the deployment of multiple antennas over a space with amplitude and phase adjustments per each antenna element to steer the beam to the desired direction. Electronic beam steerability and high gain of phased arrays are the essential enabler for the 5G and 6G wireless systems. Since the next generation communications utilize wide spectrum of high frequency bands such as millimeter-wave (mmW) and (sub-) THz bands, significantly higher path loss should be compensated by phased arrays. For phased array antennas, active reflection coefficient (ARC) is the one of the most important figures of merit. The ARC of an m-th element is defined as follows.

ARCₘ=Γₘ=Σₙ₌₁^{N}Sₘₙe^{-j(n-m)u},u=kd·sin θ (1)

where Sₘₙ is the scattering matrix of phased array, N is the number of elements, k is the wave number, d is the spacing between elements, and u is the phase shift between elements required to steer the beam to angle θ. The ARC is basically the sum of the passive reflection coefficient and couplings to all other elements weighted by the phase shift term.

Since the advent of phased array, minimizing ARC over wide scan angle has been a highly challenging problem to antenna engineers. As can be deducted from Equation (1), the impact of coupling terms on ARC can vary dramatically as the scan angle θ varies over a wide range, especially when the coupling is strong. The coupling is often dictated by the distance between antennas, and the distance is typically limited to a half-wavelength for wide angle scanning phased arrays to avoid grating lobes. Given these limitations, it is extremely difficult to maintain low ARC over wide scan angle.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided a phased array antenna for transmitting/receiving beamformed signals on a plurality of beams using a common frequency- and time-limited physical channel resource comprising:

an array of antenna cells for electromagnetic radiation, wherein the antenna cells comprise:

an antenna element;

a first coupling structure at a first side of the antenna element for manipulating coupling with an adjacent antenna cell at a first side of the antenna element;

a second coupling structure at a second side of the antenna element opposite to the first side for manipulating coupling with another adjacent antenna cell at the second side of the antenna element;

a coupling factor of the first coupling structure differing from a coupling factor of the second coupling structure;

wherein adjacent antenna cells of the array of antenna cells are mirror-symmetric structures.

According to an embodiment, the antenna cells further comprise:

a third coupling structure at a third side of an antenna element for manipulating coupling in the electric plane;

a fourth coupling structure at a fourth side of the antenna element opposite to the third side for manipulating coupling in the electric plane; and

a coupling factor of the third coupling structure differing from a coupling factor of the fourth coupling structure.

According to an embodiment, the array of antenna cells comprises N rows and M columns of antenna cells.

According to an embodiment, antenna cells of adjacent rows are mirror-symmetric and antenna cells of adjacent columns are mirror-symmetric.

According to an embodiment, the antenna is designed to operate at a predetermined frequency range.

According to an embodiment, the first coupling structure comprises a first crossbar and the second coupling structure comprises a second crossbar, wherein the size of the first crossbar is different from a size of the second crossbar.

According to an embodiment, the third coupling structure comprises a first ring and the fourth coupling structure comprises a second ring, wherein the size of the first ring is different from a size of the second ring.

According to an embodiment, the first coupling structure comprises a first stub electrically in contact with the antenna element and the second coupling structure comprises a second stub electrically in contact with the antenna element, wherein the size of the first stub is different from a size of the second stub.

According to an embodiment, the third coupling structure comprises a third stub electrically in contact with the antenna element and the fourth coupling structure comprises a fourth stub electrically in contact with the antenna element, wherein the size of the third stub is different from a size of the fourth stub.

According to a second aspect, there is provided an apparatus comprising a phased array antenna for transmitting/receiving beamformed signals on a plurality of beams using a common frequency- and time-limited physical channel resource comprising:

an array of antenna cells for electromagnetic radiation, wherein the antenna cells comprise:

an antenna element;

a first coupling structure at a first side of the antenna element for manipulating coupling with an adjacent antenna cell at a first side of the antenna element;

a second coupling structure at a second side of the antenna element opposite to the first side for manipulating coupling with another adjacent antenna cell at the second side of the antenna element;

a coupling factor of the first coupling structure differing from a coupling factor of the second coupling structure;

wherein adjacent antenna cells of the array of antenna cells are mirror-symmetric structures.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating a beam distribution arrangement according to the embodiments;

FIG. 2 shows schematically a layout of an apparatus according to an example embodiment;

FIG. 3 shows a part of an exemplifying radio access network;

FIGS. 4a and 4b show an example of a one-dimensional 1×3 linear array of dipole antennas and its active reflection coefficient;

FIGS. 4c and 4d show an example of a two-dimensional planar array of microstrip patch antennas and its active reflection coefficient over wide two-dimensional scanning;

FIG. 5 shows a conceptual drawing of an array of antennas with mirror-symmetric scatterers, in accordance with an embodiment;

FIGS. 6a and 6b show an example of an 1×3 array of dipole antennas with mirror-symmetric rings as scatterers and corresponding S-parameters, in accordance with an embodiment;

FIGS. 6c and 6d show an example of a planar array of patch antennas with mirror-symmetric scatterers and corresponding S-parameters over wide scan angles, in accordance with an embodiment;

FIGS. 6e and 6f show an example of a planar array of mirror-symmetric antennas and corresponding S-parameters over wide scan angles, in accordance with an embodiment; and

FIG. 7 shows as a simplified block diagram an example of an antenna arrangement and driving circuits for the antenna arrangement, in accordance with an approach.

### DETAILED DESCRIPTION OF SOME EXAMPLE EMBODIMENTS

The following describes in further detail suitable apparatus and possible mechanisms carrying out the active reflection coefficient management. While the following focuses on 5G networks, the embodiments as described further below are by no means limited to be implemented in said networks only, but they are applicable in any network implementing MU-MIMO (multi-user multiple input-multiple output) transmissions.

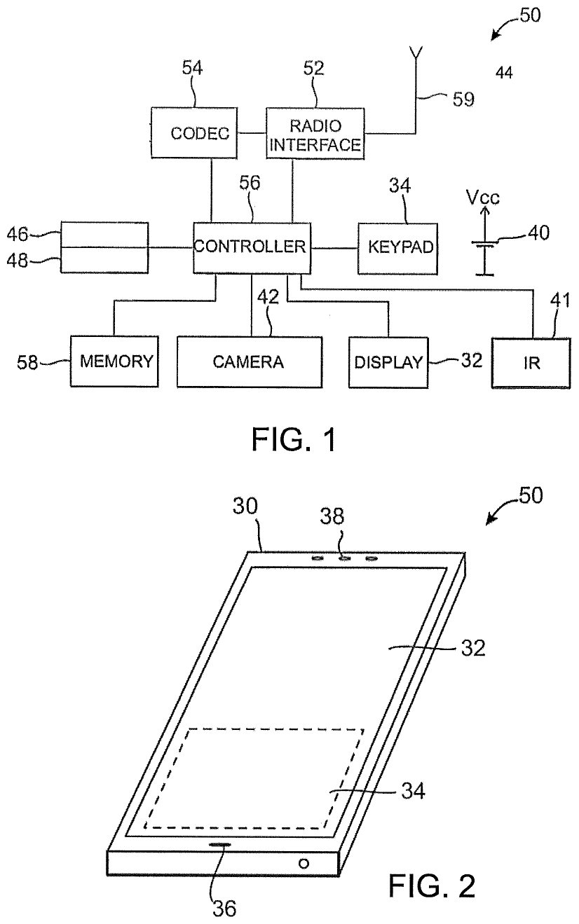

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

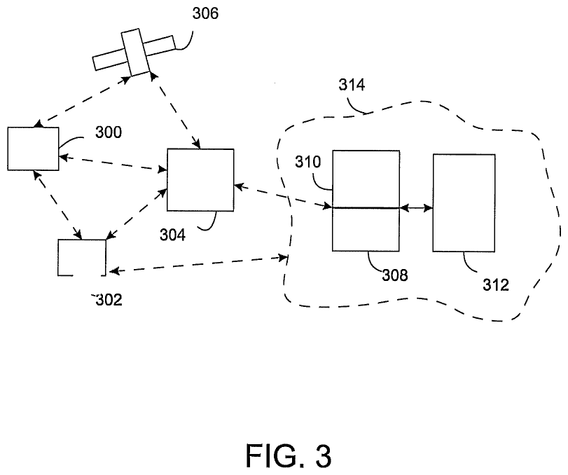

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g)NodeB) 304 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and non-real time functions being carried out in a centralized manner (in a centralized unit, CU 308).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs. Satellite communication may utilize geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states are controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

For the 5G technology, one of the most important design goals has been improved metrics of reliability and latency, in addition to network resilience and flexibility.

Especially when considering the operating of the UE in the Frequency Range 2 (FR2; 24.25 GHz to 52.6 GHz) including the mmWave range, the UE implementation is expected to have multiple antenna panels (Multi-Panel UE, MPUE) to perform beam steering over a large solid angle aiming to maximize the reliability.

In FR2, both gNB and UE are expected to operate using “narrow” beams meaning that gNB operates using radiation patterns narrower than sector-wide beams and UE operates using radiation patterns narrower than omni-directional beams. Beamformed data transmission is realized by transmitting the signal from all the elements in the antenna array in the desired direction by applying an amplitude and phase precoding/beamforming weights, i.e., beam-weights. Beamformed transmission from large antenna array in massive MIMO of a network element, such as a base station (gNb), provides improved signal strength to the desired user equipment (UE) but may create significant interference to other UEs, if the beams create unwanted interference in the direction of the other UEs.

Multiple users can be scheduled simultaneously on a frequency-time resource in multi-user MIMO (MU-MIMO) while transmitting beamformed signal in users' dominant direction. MU-MIMO improves system throughput by co-scheduling multiple UEs in the same slot on the same physical resource blocks (PRBs). The benefits of MU-MIMO can be realized only if the beamformed transmission towards one UE does not create too much interference to the other co-scheduled UEs.

The reasons for the beam-based operations depend on the need for an increased array/antenna gain to compensate the higher coupling loss at mmWaves, but it also poses some technological limitations. Beam-based operation requires a good beam correspondence between the gNB and UE, which is challenging to maintain since, with very narrow beams and, therefore, a large degree of freedom in the spatial domain, it is rather sensitive to blockages and beam misalignment between gNB and UE, as well as to mobility and rotation effects of the UE.

One method of correlation computation between the beams is to perform dot product or inner-product of their beam weights, i.e., ∥b₁^{H}b₂∥² where b₁ and b₂ are the n_{TRX}×1-length beam weight vectors of beams 1 and 2. Sometimes, the interference is also computed as ∥b′₁^{H}b′₂∥², where b′₁ and b′₂ are the

$$\frac{{n}_{TRX}}{2} \times 1$$

length beam weight vectors corresponding to a single polarization. This method may result in an inaccurate estimate of interference of one beam onto another. This is because this metric only computes the interference from one beam in the bore-sight beam direction of the other beam, but the UE can be anywhere in the beam dominance direction of a beam when the UE reports that beam as the best beam.

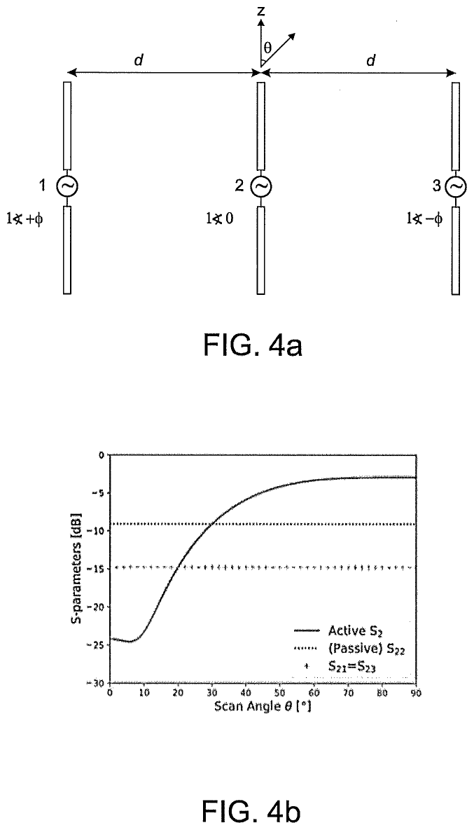

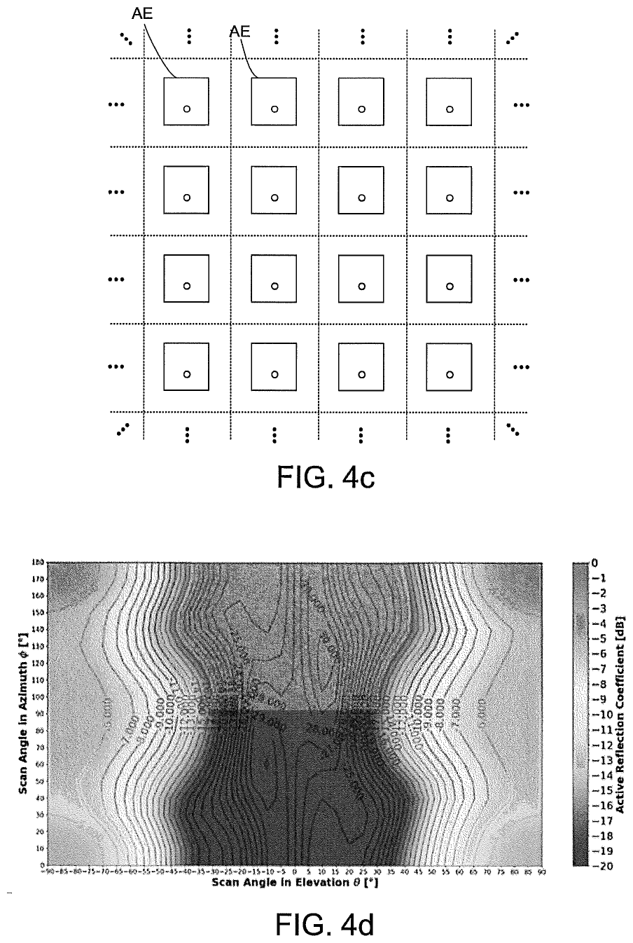

FIG. 4a shows a 1×3 linear (1D) array of dipole antennas and FIG. 4b shows its active reflection coefficient (Active S2). The distance d between dipole antennas is half-wavelength, excitation amplitudes are uniform, and the phase shift φ=kd·sin θ is assigned between elements to steer the beam. Also, the antenna array is optimized to be matched at the broadside (θ=0°), which is the typical phased array design workflow. As shown in FIG. 4b, the active impedance match quickly deviates from the broadside state (˜−25 dB) and becomes poor as the scan angle increases. Degraded ARC reduces the phased array gain and the overall system efficiency. This can be understood from how ARC is calculated in this simple 1×3 array example:

ARC₂=S₂₂+S₂₁·e^{+jϕ}+S₂₃·e^{-jϕ} (2)

Since S₂₁=S₂₃, the ARC can be expressed as follows:

ARC₂=S₂₂+2·S₂₁·cos(ϕ)=S₂₂+S₂₁·cos(kd·sin θ) (3)

As can be seen from the equation (3), the coupling terms (S₂₁ and S₂₃) are coherently added together with the cosine weighting factor. In this example, S₂₂ is around −9 dB, and S₂₁ and S₂₃ are around −15 dB. At the broadside (θ=0°), the coupling terms S₂₂, S₂₁, S₂₃ are added to achieve good ARC. However, ARC rapidly degrades as the scan angle deviates from the broadside. Minimizing coupling would render ARC less sensitive to the scan angle, but, as mentioned above, the coupling is dictated by the spacing between elements, which is usually constrained to be half-wavelength.

The active reflection coefficient problem may be very serious for not only linear arrays, but also planar arrays. FIG. 4c shows an example of a two-dimensional (2D) planar array of microstrip patch antennas AE and FIG. 4d shows its ARC over wide 2D scanning. Again, this antenna arrangement may achieve an excellent impedance match at the boresight (θ=0°), but the ARC is degraded as the scan angle increases.

In the following, an enhanced arrangement for antenna arrays will be described in more detail, in accordance with various embodiments. The antenna array comprises a plurality of antenna elements such as dipoles or patch antennas and two or more coupling structures at two sides of the radiation elements. The antenna elements may also be called as radiation elements in this disclosure. The antenna element and the coupling structures associated with the antenna element may also be called as an antenna cell or a radiation cell in this disclosure.

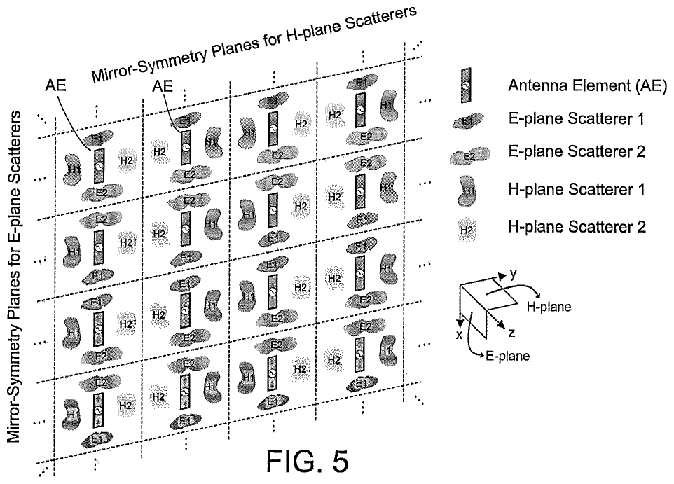

According to some embodiments the antenna array utilizes asymmetricity in a phased array unit cell and its mirror-symmetric (MirSy) deployment to achieve low ARC over wide angle scanning. For such phased arrays, couplings to adjacent unit cells become non-identical, thus, they are not coherently added as in usual phased arrays. FIG. 5 depicts the generalized concept of this disclosure. Antenna elements are deployed throughout the array, and asymmetric E- and H-plane scatterers are added between antenna elements. In this configuration, couplings to the left and to the right from one unit cell are different due to magnetic field scatterers H1 and H2, and electric field scatterers E1 and E2 generate asymmetricity in the E-plane (vertical) couplings. The purpose of creating asymmetricity in coupling is to prevent or at least reduce coherent summation of coupling terms in ARC as described in equation (2) and (3). With properly designed such scatterers, sensitivity of ARC to scan angle can be greatly mitigated.

Since a design of arbitrary scatterer for each unit cell in a large phased array may not be practical, mirror-symmetricity is adopted to minimize the design complexity. As shown in the example of FIG. 5, the electric field (E) scatterers E1, E2 and the magnetic field (H) scatterers H1, H2 are mirrored along the horizontal and vertical lines, respectively. This is illustrated in FIG. 5 so that in the horizontal rows of antenna elements AE the magnetic field (plane) scatterers H1, H2 are arranged in alternating order beside the antenna elements so that at the left-most antenna element the first magnetic plane scatterer H1 is on the left hand side of the antenna element AE and the second magnetic plane scatterer H2 is on the right hand side of the antenna element AE; at the next antenna element in the horizontal direction the first magnetic plane scatterer H1 is on the right hand side of the antenna element AE and the second magnetic plane scatterer H2 is on the left hand side of the antenna element AE, etc. Correspondingly, in the vertical rows of antenna elements AE the electric field (plane) scatterers E1, E2 are arranged in alternating order so that at the top-most antenna element the first electric plane scatterer E1 is above the antenna element AE and the second electric plane scatterer E2 is below the antenna element AE; at the next antenna element in the vertical direction the first electric plane scatterer E1 is below the antenna element AE and the second electric plane scatterer E2 is above the antenna element AE, etc.

It should be noted that the terms left, right, top and below are used here as illustrative only referring to FIG. 5 but in practical implementations the magnetic plane scatterers H1, H2 can be located at two opposite sides with respect to an antenna element, and the electric plane scatterers E1, E2 can be located at two other opposite sides with respect to the antenna element.

Since these kinds of mirror-symmetric scatterers repeat every two unit cells, one can include only four (2×2) unit cells in the design process with periodic boundary condition. Such 2×2 unit cells may then be repeated to obtain an antenna array of desired size. For example, 8×8 antenna array may be obtained by implementing two 2×2 unit cells in two rows, i.e., implementing four 2×2 unit cells in a form of a 2×2 array.

It should be noted that the mirror-symmetricity is not limited to scatterers, but, for example, the radiator itself can be designed asymmetrically and mirrored as will be described later in this disclosure.

Compared to other methods for wide scan angle impedance matching, this method does not require extra dielectric or circuit layer. In fact, the problem of ARC over wide angle scanning is solely addressed on the antenna aperture layer without increasing the cost. Therefore, embodiments of the disclosure can be applicable to nearly any antenna types of phased array. Furthermore, the antenna arrangement and method may be scalable to any frequency range including mmW and (sub-)THz bands for 5G/6G applications.

One key aspect is the asymmetric couplings to neighbouring unit cells so that they are not added coherently in ARC. Asymmetricity can be accomplished by different geometric forms such as scatterers, stubs, and so forth. Such elements effecting the asymmetricity in the coupling in the electric plane and in the magnetic plane may also be called as coupling manipulating structures or coupling manipulating elements in this disclosure.

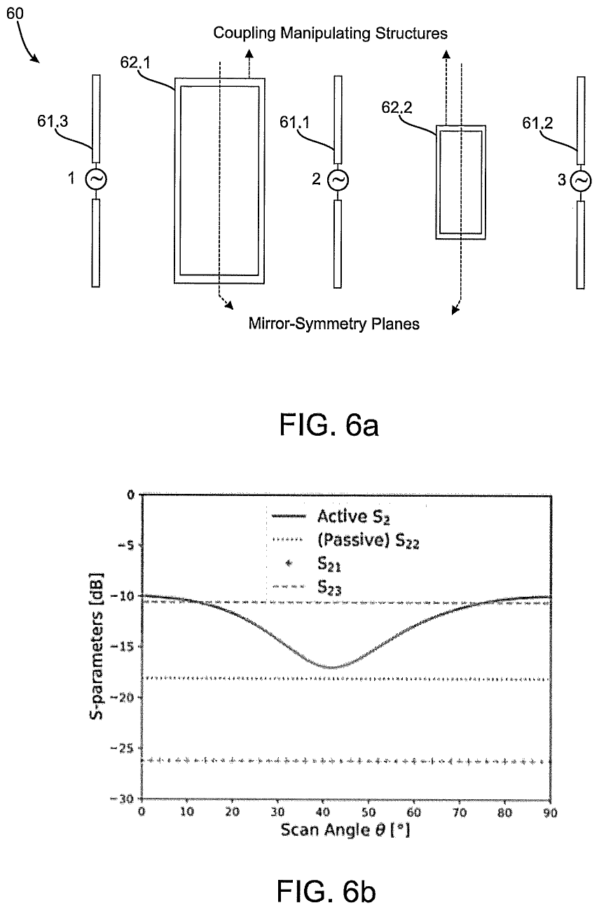

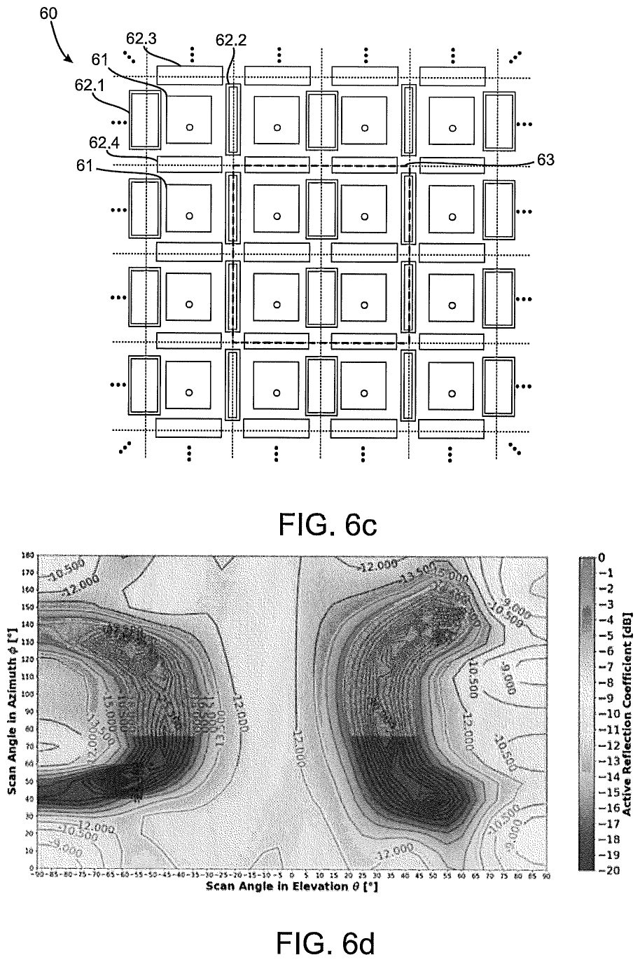

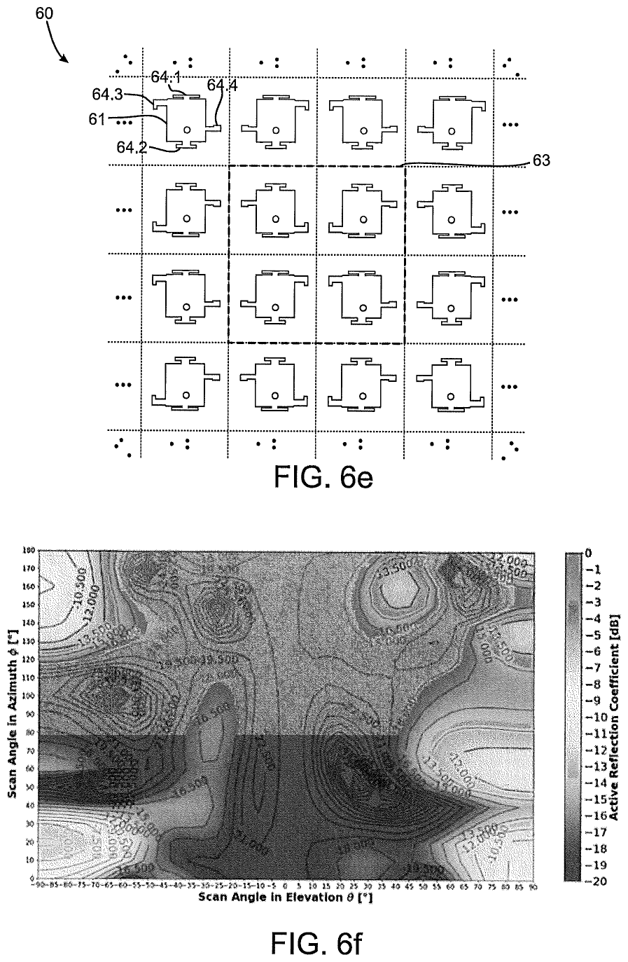

In the following, three exemplary phased array designs and their ARC performance over wide scan range are described with reference to FIGS. 6a-6f.

FIG. 6a illustrates an embodiment of an antenna arrangement 60 comprising a 1×3 linear array of dipole antennas 61 with asymmetric ring scatterers 62. The dotted lines in the middle of the ring scatterers 62 indicate the location of the mirror-symmetry planes. Due to the different coupling factors of the scatterers 62, the coupling from the middle antenna element 61.1 via a first scatterer 62.1 to the adjacent antenna element 61.2 on the right (S23) is much stronger than the coupling from the middle antenna element 61.1 via a second scatterer 62.2 to the adjacent antenna element 61.2 on the left (S21). Having optimized the dimensions of scatterers 62, this phased array antenna may achieve ARC below −10 dB over the entire scan range as is shown in FIG. 6b.

FIG. 6c illustrates another embodiment of an antenna arrangement 60 comprising a planar array of microstrip patch antennas 61 with mirror-symmetric scatterers 62. Ring scatterers 62.1, 62.2 are used to manipulate magnetic plane (H-plane) couplings, and crossbar scatterers 62.3, 62.4 control the electric plane (E-plane) couplings. Thanks to mirror-symmetricity, only a 2×2 sub-array 63 with periodic boundary condition (BC) is included in the optimization process. Also in FIG. 6c the dotted lines in the middle of the ring scatterers 62 indicate the location of the mirror-symmetry planes. After optimized, the 2×2 sub-array 63 is copied in vertical and horizontal directions so that an 8×8 finite phased array is obtained. This array was simulated, and ARC over the upper hemisphere is shown as a contour plot in FIG. 6d. It can be seen that the ARC is below −10 dB over an extremely wide scan angle (−70°<0<+70°, 0<˜<+180°). The worst ARC in the full hemisphere is still lower than −7 dB.

Ring scatterers may also be called as parallelogram scatterers if two opposite sides are mutually equal in length and the other two opposite sides are also mutually equal in length, however, these two lengths need not be equal. If the corners of the parallelogram are each 90 degrees, the structure may also be called as a rectangle.

To demonstrate the point that the coupling manipulation can be achieved by arbitrary geometric forms other than scatterers, microstrip patch array with mirror-symmetric stubs was designed as shown in FIG. 6e. Herein, T-shaped stubs 64.1, 64.2 are formed at opposite sides of the patches 61 so that the T-shaped stubs 64.1, 64.2 of one patch 61 are not identical but have some differences in their geometry to provide different coupling in the electric plane. Correspondingly, L-shaped stubs 64.3, 64.4 are formed at opposite sides of the patches 61 in an orthogonal direction with respect to the T-shaped stubs 64.1, 64.2 so that the L-shaped stubs 64.3, 64.4 of one patch 61 are not identical but have some differences in their geometry to provide different coupling in the magnetic plane. The stubs 64.1, 64.2, 64.3, 64.4 are electrically in contact with the patch 61.

FIG. 6e illustrates simulation results. The contour plot of ARC indicates that similar ARC performance over wide scan range can be achieved by such mirror-symmetric stubs 64.1, 64.2, 64.3, 64.4.

The size and form of the coupling manipulating elements may be different in different embodiments and may also depend on the frequency range intended for such antenna arrangement. Also the design of the antenna elements may affect to the design of the coupling manipulating elements.

It should be noted that the coupling manipulating elements in the gaps between adjacent antennas 61 can be considered as a combination of a coupling manipulating element of one antenna and a neighbouring coupling manipulating element of the adjacent antenna. For example, a first half of the ring-formed coupling manipulating element would be considered as being the coupling manipulating element of the one antenna and a second half of the ring-formed coupling manipulating element would be considered as being the coupling manipulating element of the adjacent antenna, as was illustrated with the mirror-symmetry planes in FIGS. 6a and 6c.

The antenna arrangement may be designed to operate at a predetermined frequency range f1 to f2, f2>f1. The mutual distance d of antenna elements in the antenna arrangement may thus be adjusted to be around the half of the wavelength at the highest frequency of interest. In accordance with an embodiment, the distance d is the distance between centre lines of two neighbouring antennas. When the geometric shape of the antennas cell grid is quite regular (e.g. a rectangle), the centre line may be easy to determine but with more complicated geometric shapes the centre line may be estimated or determined on the basis of a periodicity of the cell shape, for example.

In some embodiments the antenna arrangement may be manufactured on a substrate having a conductive layer on the surface of the substrate, wherein the patterns for the antennas and coupling manipulating structures may be formed by removing (e.g. by etching) unnecessary areas of the conductive layer.

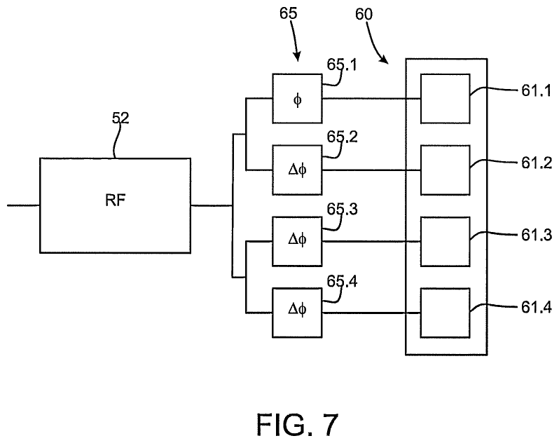

FIG. 7 shows as a simplified block diagram an example of an antenna arrangement 60 and driving circuitry 65 for the antenna arrangement 60, in accordance with an approach. The driving circuitry 65 comprises a phase shifter for each antenna cell of the antenna arrangement 61. In this example the antenna arrangement 61 is a 1×4 array of antenna cells 61.1-61.4 but similar principle is also applicable to different number of antenna cells in an antenna arrangement. The RF part 52 provides radio frequency signals for transmission by the antenna arrangement 60. The radio frequency signals are provided to the phase shifters 65.1-65.4 of the driving circuitry. The phase shifts caused by the phase shifters 65.1-65.4 to the radio frequency signals are set so that a main beam of a radiation pattern of the antenna arrangement 60 is directed to a desired transmission direction, which may change during operation of the apparatus 50. Similar principle can be used when the antenna arrangement 60 is used to receive radio frequency signals, wherein each phase shifter 65.1-65.4 causes a certain phase shift to signals received by the antenna elements so that the radiation pattern of the antenna arrangement 60 is directed to a desired reception direction.

An apparatus, such as a base station (gNb), according to an aspect comprises a multiple input-multiple output (MIMO) antenna comprising an array of antenna cells for transmitting beamformed signals using a common frequency- and time-limited physical channel resource; means for adjusting phase shifts to signals provided to antenna cells for obtaining a radiation pattern having a main beam towards a desired transmission direction.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. A phased array antenna for at least one of transmitting or receiving beamformed signals on a plurality of beams using a common frequency- and time-limited physical channel resource, said phased array antenna comprising:
an array of antenna cells for electromagnetic radiation, wherein the antenna cells comprise:
an antenna element;
a first coupling structure at a first side of the antenna element for manipulating coupling with an adjacent antenna cell at a first side of the antenna element;
a second coupling structure at a second side of the antenna element opposite to the first side for manipulating coupling with another adjacent antenna cell at the second side of the antenna element; and
a coupling factor of the first coupling structure differing from a coupling factor of the second coupling structure;
wherein adjacent antenna cells of the array of antenna cells are mirror-symmetric structures.

2. The antenna according to claim 1, wherein the first coupling structure comprises a first crossbar and the second coupling structure comprises a second crossbar, wherein a size of the first crossbar is different from a size of the second crossbar.

3. The antenna according to claim 1, wherein the first coupling structure comprises a first stub electrically in contact with the antenna element and the second coupling structure comprises a second stub electrically in contact with the antenna element, wherein a size of the first stub is different from a size of the second stub.

4. The apparatus according to claim 1, comprising
a third coupling structure at a third side of an antenna element for manipulating coupling in the electric plane;
a fourth coupling structure at a fourth side of the antenna element opposite to the third side for manipulating coupling in the electric plane; and
a coupling factor of the third coupling structure differing from a coupling factor of the fourth coupling structure.

5. The antenna according to claim 4, wherein the array of antenna cells comprises N rows and M columns of antenna cells.

6. The antenna according to claim 5, wherein the antenna cells of adjacent rows are mirror-symmetric and antenna cells of adjacent columns are mirror-symmetric.

7. The antenna according to claim 4, wherein the third coupling structure comprises a first ring and the fourth coupling structure comprises a second ring, wherein a size of the first ring is different from a size of the second ring.

8. The antenna according to claim 7, wherein the third coupling structure comprises a third stub electrically in contact with the antenna element and the fourth coupling structure comprises a fourth stub electrically in contact with the antenna element, wherein a size of the third stub is different from a size of the fourth stub.

9. The antenna according to claim 1, wherein the first coupling structure of the one antenna element and a second coupling structure of an adjacent antenna element are combined as one coupling manipulating structure in between the one antenna element and the adjacent antenna element.

10. An apparatus comprising a phased array antenna for at least one of transmitting or receiving beamformed signals on a plurality of beams using a common frequency- and time-limited physical channel resource, said phased array antenna comprising:
an array of antenna cells for electromagnetic radiation, wherein the antenna cells comprise:
an antenna element;
a first coupling structure at a first side of the antenna element for manipulating coupling with an adjacent antenna cell at a first side of the antenna element;
a second coupling structure at a second side of the antenna element opposite to the first side for manipulating coupling with another adjacent antenna cell at the second side of the antenna element; and
a coupling factor of the first coupling structure differing from a coupling factor of the second coupling structure;
wherein adjacent antenna cells of the array of antenna cells are mirror-symmetric structures.

11. The apparatus according to claim 10, wherein the first coupling structure comprises a first crossbar and the second coupling structure comprises a second crossbar, wherein a size of the first crossbar is different from a size of the second crossbar.

12. The apparatus according to claim 10, wherein the first coupling structure comprises a first stub electrically in contact with the antenna element and the second coupling structure comprises a second stub electrically in contact with the antenna element, wherein a size of the first stub is different from a size of the second stub.

13. The apparatus according to claim 10, comprising
a third coupling structure at a third side of an antenna element for manipulating coupling in the electric plane;
a fourth coupling structure at a fourth side of the antenna element opposite to the third side for manipulating coupling in the electric plane; and
a coupling factor of the third coupling structure differing from a coupling factor of the fourth coupling structure.

14. The apparatus according to claim 13, wherein the array of antenna cells comprises N rows and M columns of antenna cells.

15. The apparatus according to claim 14, wherein the antenna cells of adjacent rows are mirror-symmetric and antenna cells of adjacent columns are mirror-symmetric.
